(19) United States
(12) Patent Application Publication
(10) Pub. No.: US 2008/0279279 A1
(43) Pub. Date: Nov. 13, 2008

(54) Content adaptive motion compensated temporal filter for video pre-processing

(76) Inventors: Wenjin Liu, Cupertino, CA (US); Jian Wang, Sunnyvale, CA (US); Zhang Yong, Santa Clara, CA (US)

Correspondence Address: INNOVATION MANAGEMENT SCIENCES, P. O. BOX 1169, LOS ALTOS, CA, 94023-1169, US

(21) Appl. No.: 11/801,744

(22) Filed: May 9, 2007

(51) Int. Cl. H04N 7/12

(52) U.S. Cl. 375/240.16; 375/E07.105

(57) ABSTRACT

A method of processing a video sequence is provided. The video sequence includes a plurality of video frames, wherein each of the plurality of video frames includes a plurality of macroblocks. Further, each of the plurality of macroblocks includes a plurality of pixels. The method includes determining energy values for pixels in a first macroblock and a second macroblock, determining a respective attenuation factor for each of the plurality of pixels in the first macroblock and determining a modified intensity value for each of the plurality of pixels in the first macroblock based on the respective attenuation factor for each of the plurality of pixels in the first macroblock, a respective intensity value of each of the plurality of pixels in the first macroblock and a mean intensity value of the first macroblock.

### FIELD OF THE INVENTION

The invention relates generally to the field of video encoding. More specifically, the invention relates to a pre-processing filter.

### BACKGROUND OF THE INVENTION

Various compression tools are used for compressing images or video frames before transmission. The compression tools are defined by various international standards they support. Examples of international standards include, but are not limited to, H.263, H.264, MPEG2 and MPEG4. However, the compression tools do not consider the noises, for example, white Gaussian noise, random noise, and salt and pepper noise, introduced in the images. Thus to improve compression efficiency, removal of noise is desired.

Video compression algorithm mainly includes three processes: Encoding, Decoding and Pre- and Post-processing. To smoothen the compression process of the image, filtering of the image is done prior to the encoding process. However, filtering needs to be done in such a way that the details and textures in the image remain intact. Currently available pre-processing systems include simple low-pass filters, such as mean filter, median filter and Gaussian filter, which keep the low frequency components of the image and reduce the high frequency components. U.S. Pat. No. 6,823,086 discloses a system for noise reduction in an image using four 2-D low-pass filters. The amount of filtering is adjusted for each pixel in the image using weighting coefficients. Different filters are used as the low-pass filters, for example, 2D half-band 3×3 filter and 5×5 Gaussian filters. However, the patent does not provide clear information for the calculation of the weighting coefficients. Another U.S. Pat. No. 5,491,519, discloses a method for adaptive spatial filtering of a digital video signal based on the frame difference. The frame difference is computed without motion compensation. As such, the method causes the moving contents of digital video signal to blur.

Yet another low-pass noise filter used is the Gaussian filter. U.S. Pat. No. 5,764,307 discloses a method for spatial filtering of video signal by using a Gaussian filter on displaced frame difference (DFD). However, the method has high complexity and requires multiple-pass processing of the source video. Another U.S. Pat. No. 6,657,676, discloses a spatial-temporal filter for video coding. A filtered value is computed using weighted average of all pixels within a working window. This method also has very high complexity.

Low-pass filters, used in prior art, for filtering images remove high frequency components within frames. High frequency components are responsible for producing sharpness of the image. Thus, removal of high frequency components produces blurring of edges in the image. Hence, a spatial/temporal filter is desired to remove noises and high frequency components within each frame for varied scenarios. Further, it is desired to incorporate adaptive features into filtering process to significantly attenuate noise and improve coding efficiency. Moreover, it is desired to preserve boundaries and details in the image during filtering.

### SUMMARY

A method of processing a video sequence, including an efficient pre-processing algorithm before video compression process, is provided. The video sequence includes a plurality of video frames, wherein each of the plurality of video frames includes a plurality of macroblocks. Each of the plurality of macroblocks comprises a plurality of pixels. The method includes determining a respective first energy value for each of the plurality of pixels in a first macroblock, determining a respective second energy value for each of the plurality of pixels in a second macroblock, determining a respective attenuation factor for each of the plurality of pixels in the first macroblock based on the first energy value, the second energy value and a respective weighted filter strength factor associated with each of the plurality of pixels in the first macroblock; and determining a modified intensity value for each of the plurality of pixels in the first macroblock based on the respective attenuation factor for each of the plurality of pixels in the first macroblock, a respective intensity value of each of the plurality of pixels in the first macroblock and a mean intensity value of the first macroblock.

The system includes a filter strength determining module to determine a weighted filtering strength factor for each of the plurality of pixels in a first macroblock and an intensity updating module to determine an updated intensity value for each of the plurality of pixels in the first macroblock using the weighted filtering strength factor.

### BRIEF DESCRIPTION OF THE DRAWINGS

The present invention will now be described with reference to the accompanied drawings that are provided to illustrate various example embodiments of the invention. Throughout the description, similar reference names may be used to identify similar elements.

FIG. 1 depicts an exemplary video frame of video data in accordance with various embodiments of the invention.

FIGS. 2a and 2b depict a flowchart, illustrating a method for filtering a pixel of a video frame, in accordance with an embodiment of the invention;

FIG. 3 is a flowchart, illustrating a method for determining a weighted strength filtering factor, in accordance with an embodiment of the invention;

FIG. 4 is a flowchart, illustrating a method for determining an energy value, in accordance with one embodiment of the invention;

FIGS. 5a and 5b depict a flowchart, illustrating a method for determining an energy value, in accordance with another embodiment of the invention;

FIG. 6 illustrates an environment in which various embodiments of the invention may be practiced;

FIG. 7 is a block diagram of a preprocessing filter, in accordance with an embodiment of the invention;

FIG. 8 is a block diagram of a filter strength determining module, in accordance with an embodiment of the invention; and

FIG. 9 is a block diagram of an intensity updating module, in accordance with one embodiment of the invention.

### DESCRIPTION OF VARIOUS EMBODIMENTS

Various embodiments of the invention provide a method, system and computer program product for filtering a video frame. A video frame, divided into macroblocks, is input into a pre-processing filter, following which a spatial filter is applied to a macroblock to categorize each of the pixels in the macroblock. Intra prediction and motion estimation is performed on the macroblock. Thereafter, according to the mode selected, motion compensation is performed on the macroblock. A temporal filter is then applied and the video frame is coded.

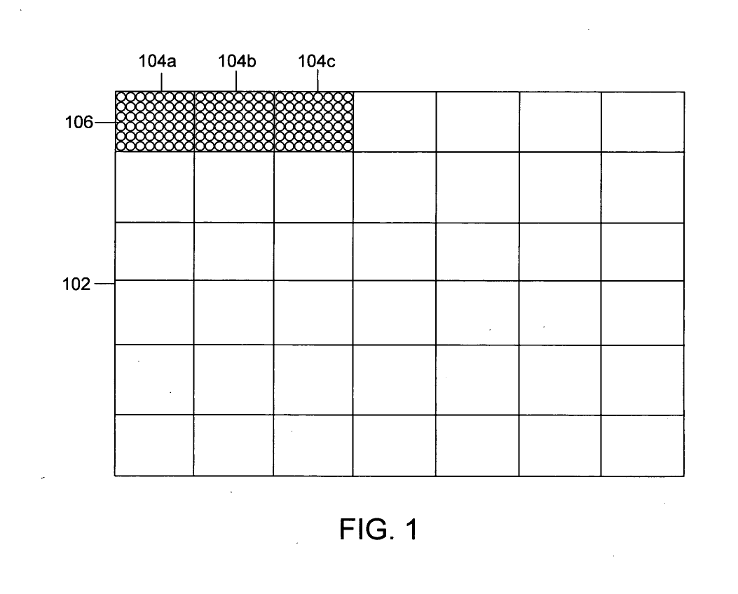

FIG. 1 depicts an exemplary video frame 102 in accordance with an embodiment of the invention. Video frame 102 is divided into a plurality of macroblocks, such as macroblocks 104, including for example macroblocks 104a, 104b and 104c. A macroblock is defined as a region of a video frame coded as a unit, usually composed of 16×16 pixels. However, different block sizes and shapes are possible under various video coding protocols. Each of the plurality of macroblocks 104 includes a plurality of pixels. For example, macroblock 104a includes pixels 106. Each of the macroblocks 104 and pixels 106 includes information such as color values, chrominance and luminance values and the like.

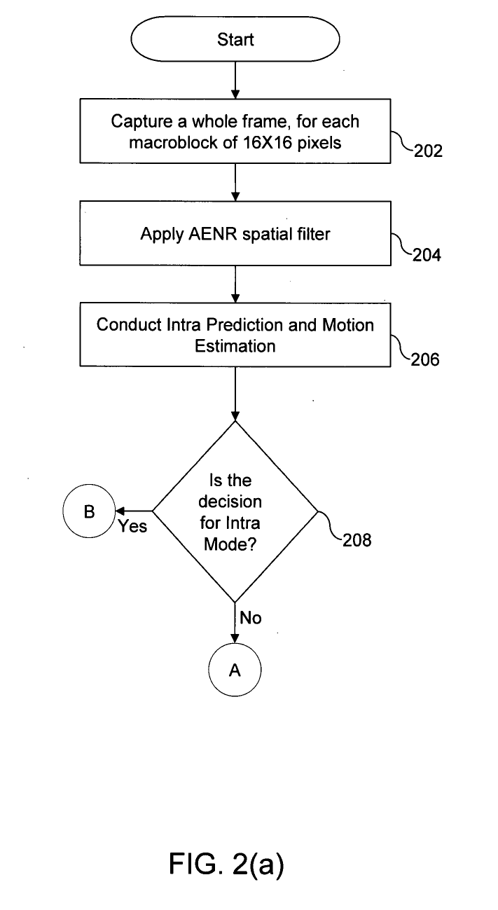

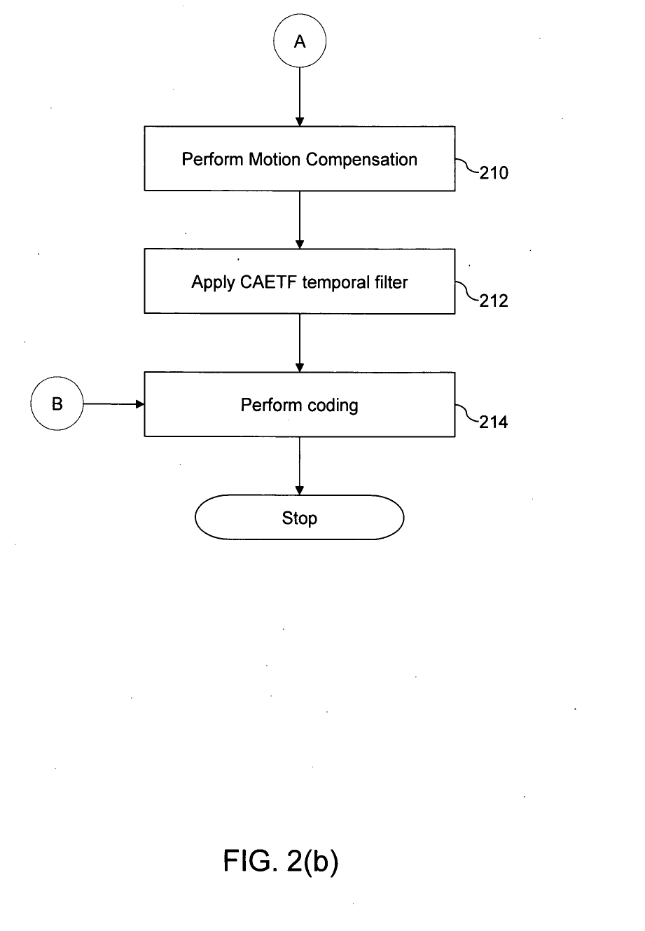

FIGS. 2a and 2b depicts a flowchart, illustrating a method for filtering a pixel of a video frame, in accordance with an embodiment of the invention. At step 202, a video frame such as video frame 102 is extracted from an input image, comprising a plurality of video frames. Video frame 202 is divided into macroblocks 104 of 16×16 pixels, such as pixels 106.

At step 204, an Adaptive Edge Based Noise Reducer (AENR) spatial filter is applied to the macroblock 104a. Applying the AENR spatial filter includes three main steps: The first step includes determining categories for each of pixels 106. The categories are selected from four image categories depending upon a luminance level associated with each of pixels 106. The categories include “flat pixel”, “noise pixel”, “edge pixel”, and “rich texture pixel”. Thereafter, each pixel is categorised into one of the above categories using a human-vision-system-based look up table. A detailed description of the AENR step and an explanation of the four filters is provided in a commonly owned co-pending U.S. patent application Ser. No. 10/638,317 entitled ‘Method, system and computer program product for filtering an image’, filed on Dec. 13, 2006.

At step 206, intra prediction and motion estimation is performed on macroblock 104a. At step 208, a decision for selecting the mode of prediction is made. The modes are selected from an intra mode or inter mode.

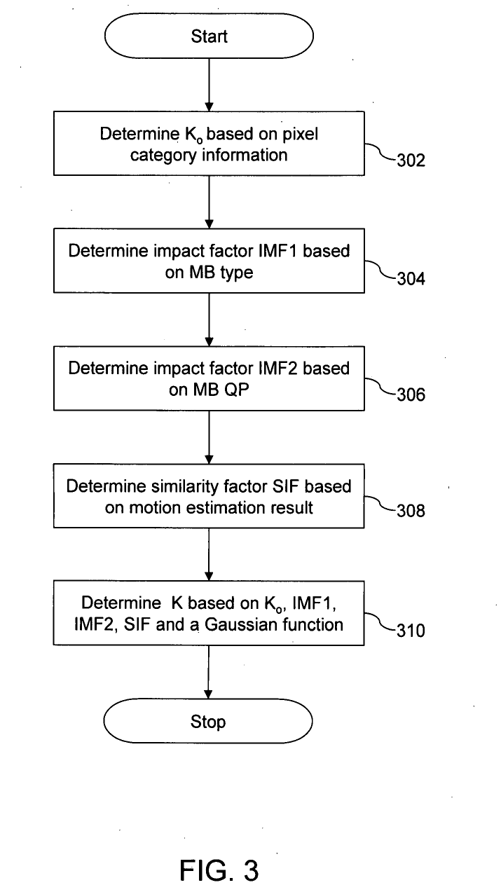

At step 208, it is determined if the mode is an intra mode. If the mode determined is not an intra mode, then at step 210, motion compensation is performed on a first macroblock, hereinafter referred to as macroblock 104a. Motion compensation performed on macroblock 104a produces a second macroblock, hereinafter referred to as a residual macroblock. Else, if the mode selected is an inter mode, then video frame 102 is coded at step 214. Thereafter, at step 216, a Content Adaptive Energy based Temporal Filter (CAETF) is applied on macroblock 104a. The CAETF is a temporal filter that is applied on a video frame to modify the intensity value of pixel 106 according to the energy of pixel 106. A detailed description of CAETF is provided in conjunction with FIGS. 3 to 5. High frequencies that are present in macroblock 104a but not in the motion compensated residual macroblock represent trackable content, and therefore should be preserved. The remaining high frequencies are attenuated, as the remaining frequencies are either noise or non-trackable content. The examples of noise include white Gaussian noise, salt and pepper noise, and random noise.

FIG. 3 is a flowchart, illustrating a method for determining a weighted strength factor, K, in accordance with an embodiment of the invention. It should be noted that the weighted strength factor, K, (sometimes referred herein as a weighted filtering strength factor) is not a filter value. Rather it is a factor that indicates the strength of the filter. At step 302, an initial weighted filtering strength factor, Kₒ for pixel 106 in macroblock 104a is initialized according to a predetermined category of pixel 106. The predetermined category is determined by applying AENR filter. For example, by applying AENR filter, the following matrix is obtained:

```
Pixel_category_info 4×4[16]={Flat, Flat, Rich, Edge,
                          Flat, Flat,  Flat, Edge,
                          Flat, Flat,  Flat, Noise,
                          Flat, Flat,  Flat, Flat }
```

The following information is obtained from the above matrix:

Flat_pixels_count=12

Edge_pixels_count=2

Rich_pixels_count=1

Noise_pixels_count=1

Using the count values determined, Kₒ is determined using the following logic:

```
    K₀ = 1
If (flat_pixels_count>8)
    K₀=1.2
Else if (Noise_pixels_count>8)
    K₀=1.6
Else if (Rich_pixels_count>8)
    K₀=0.2
Else if (Edge_pixels_count>8)
    K₀=0.4
```

Therefore, according to the algorithm, K₀=1.2, since the flat_pixels_count is greater than 8 (as half of the pixels in the current 4×4 block are processed).

At step 304, a first impact factor IMF1 is determined for macroblock 104a. The first impact factor is based on the size of macroblock 104a. In one embodiment, the value of IMF1 is determined as:

$$IMF 1 = \{ \begin{matrix}2 & MB type is 16 \times 16 \\ 1 & MB type is 16 \times 8 or 8 \times 16 \\ 0 & MB type is 8 \times 8 \\ - 1 & MB type is 8 \times 4 or 4 \times 8 \\ - 2 & MB type is 4 \times 4\end{matrix} \qquad \text{-} ( 1 )$$

For example, if the best matching macroblock type is determined to be 16×8, the value of IMF1 is set to 1.

At step 306, a second impact factor IMF2 is determined for macroblock 104a. The second impact factor IMF2 is based on the quantization parameter applied on macroblock 104a. In one embodiment of the invention IMF2 is set equal to quantization parameter. For example, if the quantization parameter for macroblock 104a is equal to 26, the value of IMF2 is also set to 26.

At step 308, a similarity factor SIF is determined for macroblock 104a. The similarity factor is based on the results obtained after motion compensation. The similarity factor is determined using the following equation (2):

$$SIF = \{ \begin{matrix}0 & \overline{u} = 0 \\ \overline{m} / \overline{u} & \overline{u} \neq 0\end{matrix} \qquad \text{-} ( 2 )$$

wherein m̅ is the mean intensity value of the difference macroblock between macroblock 104a and the compensated macroblock. and ū is the mean intensity value of macroblock 4 by 4. The values of m̅ and ū are calculated using the following equations:

$$\begin{matrix}\overline{u} = \frac{1}{16} {\sum }_{i = 1}^{16} {x}_{i} & \text{-} ( 3 ) \\ \overline{m} = \frac{1}{16} {\sum }_{i = 1}^{16} {p}_{i} & \text{-} ( 4 )\end{matrix}$$

wherein xᵢ is the intensity values of every pixel in macroblock 104a, pᵢ is the intensity values of every pixel in residual macroblock.
An example for the SIF computation is as follows:
The intensity values of the pixels in current macroblock:

### Current_block4×4[16]={56, 56, 59, 65, 69, 72, 72, 72, 74, 113, 80, 83, 83, 85, 86, 88}

The intensity values of pixels in residual macroblock:

### Residual_block4×4[16]={−3, 6, 8, −4, −1, 3, 3, 2, 5, 30, 3, −6, −4, 5, 7, 4};

Block information:
The summation value for the current macro block:

### Sum_current_block4×4=1213.

The mean intensity value for the current macroblock:

### Mean_current_block4×4=1213/16=75

The summation value for the residual macroblock:

### Sum_residual_block4×4=58

The mean intensity value for the residual macroblock:

### Mean_residual_block4×4=3

Using equation (2), the similarity factor SIF is determined as follows:
mean_residual_block4×4/mean_current_block4×4=3/75=0.013

At step 310, a weighted filtering strength factor K is determined using initialized weighted filtering strength factor Kₒ, the first impact factor IMF1, the second impact factor IMF2, the similarity factor SIF and a Gaussian function. In one embodiment of the present invention, the weighted filtering strength factor K is determined by using the following Gaussian function:

$$K = {K}_{0} \times \frac{{e}^{- \frac{1}{2} {( \frac{SIF}{σ} )}^{2}}}{\sqrt{2 π} σ} \qquad \text{-} ( 5 )$$

wherein the parameter σ is calculated using the following equation:

σ=0.01×(IMF1+IMF2) (6)

For example, using the values, Kₒ=1.2, IMF1=1, IMF2=26 and SIF 0.013, K=1.47×1.2=1.77 according to equation (5).

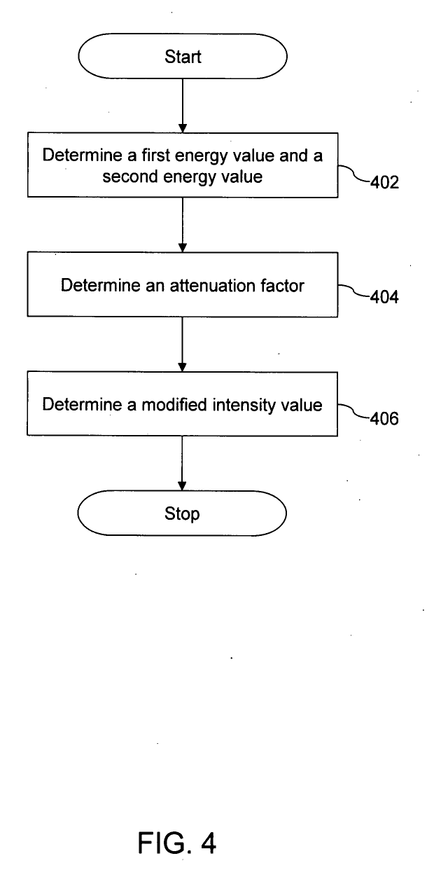

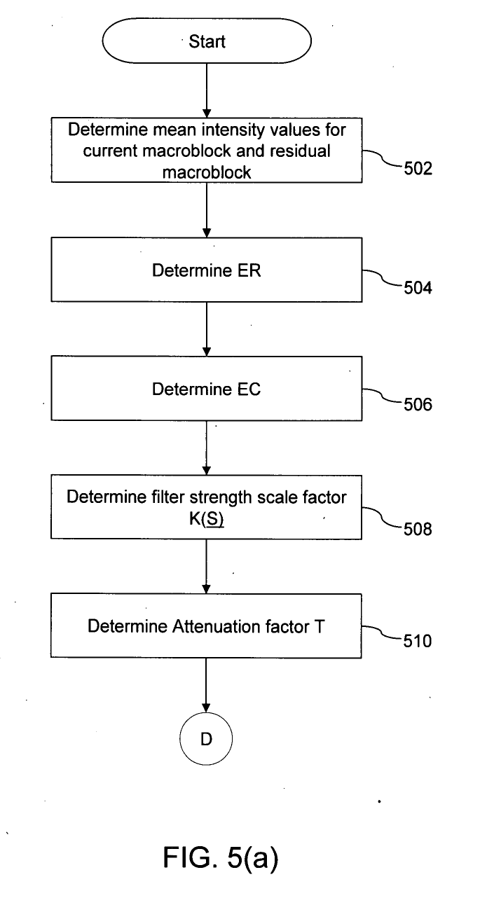

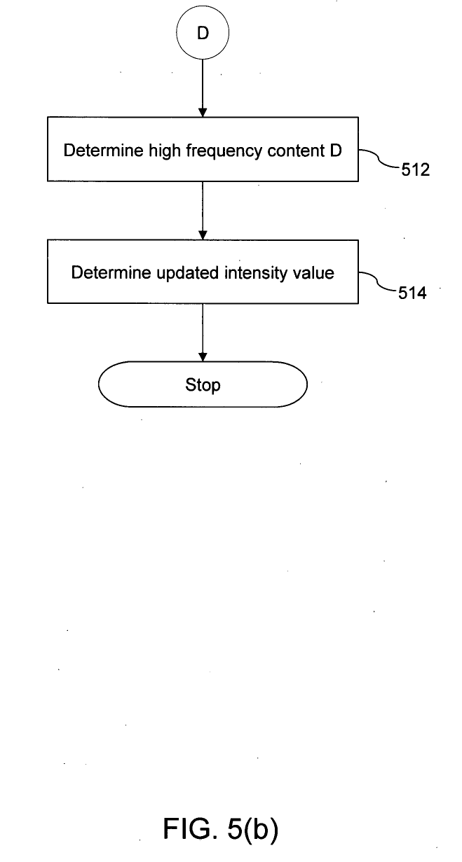

FIG. 4 is a flowchart, illustrating a method for determining an energy value for a pixel in macroblock 104a, in accordance with an embodiment of the invention. At step 402, the energy of each of pixels 106 in macroblock 104a and energy of each of pixels 106 in residual macroblock is determined. At step 404, an attenuation factor T for each of pixels 106 is determined. The attenuation factor T is explained in conjunction with FIG. 5. Thereafter, at step 406, the intensity value of each of pixels 106 is updated using the attenuation factor and energy values for each of pixels 106.

FIGS. 5a and 5b depict a flowchart, illustrating a method for determining an energy value, in accordance with another embodiment of the invention. At step 502, the average energy value of macroblock 104a and residual macroblock are determined. The average energy values are determined using equation (3) and equation (4) as described with reference to FIG. 4. At step 504, a first energy value (EC) for each of pixels 106 is determined using the following equation

EC=(xᵢ−ū)² (7)

At step 506, a second energy value (ER) for each of the pixels in residual macroblock is determined using the following equation:

ER=(pᵢ− m̅)² (8)

Here, xᵢ is the intensity values of every pixel in the macroblock 104a, pᵢ is the intensity values of every pixel in residual macroblock.

For example, using the values, K=1.77,

ER=(−3−3)×(−3−3)=36 and

EC=(56−75)×(56−75)=361

At step 508, the weighted filtering strength factor K is determined using equation (2), (3), (4), (5), and (6) as described with reference to step 310 of FIG. 3., which is based on multiple factors including, but not limited to, quantization parameter, size of macroblock 104a and Sum of Absolute Difference (SAD). The weighted filtering strength factor, K, is important for noise reduction and detail preservation. Its computation is based on both spatial and temporal information, such as pixel classification information, motion estimation information, macroblock type, and quantization parameter. At step 510, the attenuation factor T is determined using the following equation:

$$T = \{ \begin{matrix}t & 0 < t < 1 \\ 1 & t \geq 1 \\ 0 & t \leq 0\end{matrix} , \\ where \\ t = K \cdot \frac{ER}{ER + EC} . \qquad \text{-} ( 9 )$$

For example, using values K=1.77, ER=36, and EC=361, T is calculated as follows:

$$T = K \times \frac{ER}{ER + EC} = 1.77 \times \frac{36}{36 + 361} = 0.15$$

At step 512, high frequency content value D is determined for each of pixels 106. For each pixel, the high frequency content value D is the difference between its value the average value of the 4×4 block that it belongs to. It is important to identify high frequency content, since noise will introduce high frequency content. If a pixel is determined to be corrupted by noise, then the high frequency content of its pixel value will be removed to reduce noise. For example, high frequency content for a normal pixel and a noise pixel is calculated as follows:

### Normal Pixel:

ER=(−3−3)×(−3−3)=36

EC=(56−75)×(56−75)=361

T=ER/(ER+EC)=36/(36+361)=0.09

D=Current pixel intensity value−Mean_current_block4×4=56−75=−19

### Noise Pixel:

ER=(30−3)×(30−3)=729

EC=(113−75)×(113−75)=1444

T=ER/(ER+EC)=729/(729+1444)=0.34

D=Current pixel intensity value−Mean_current_block4×4=113−75=38

As could be seen from the above example, noisy pixels normally have much larger high frequency content than the less noisy pixels. It is desirable to remove the high frequency content in order to reduce noise and improve the subjective quality.

At step 514, a modified intensity value is determined for each of pixels 106. The modified intensity value, for both luma and chroma components of the pixel, is determined by using the following equation:

xₙ=xᵢ−T×(xᵢ−ū) (10)

where xₙ indicates the modified intensity value.
For example, using T=0.09 for normal pixel and T=0.34 for noise pixel in equation (10):

### Normal Pixel:

Modified intensity value=Current pixel intensity value−K×T×D=56−1×0.09×(−19)=57

### Noise Pixel:

Modified intensity value=Current pixel intensity value−K×T×D=113−1×0.34×38=100

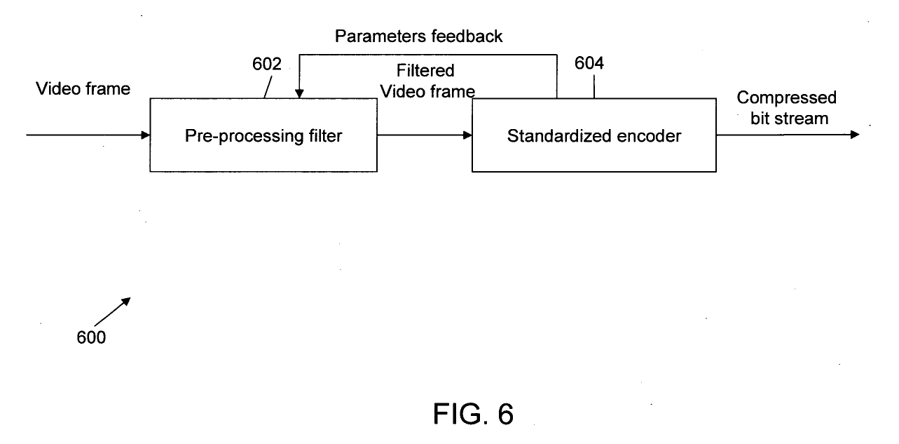

FIG. 6 depicts a system 600 in which various embodiments of the invention may be practiced. System 600 includes a pre-processing filter 602 and an encoder 604. Video frame 102 is input into pre-processing filter 602. Pre-processing filter 602 filters video frame 102 and the process of filtering includes reducing noises such as white Gaussian noise, salt and pepper noise, random noise and the like.

Video frame 102 is input into encoder 604 to obtain a compressed bit stream Encoder 604 may be embodied as a standard encoder known in the art that are compatible with codecs such as H.263, H.264, MPEG4 and the like.

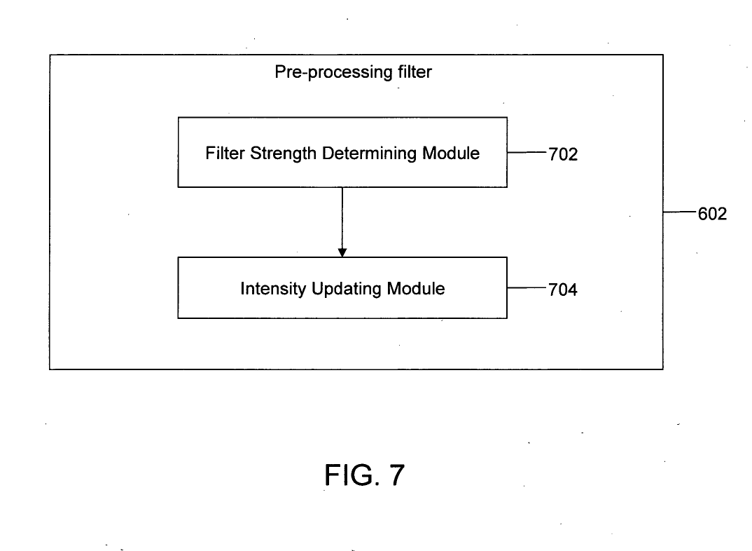

FIG. 7 is a block diagram of pre-processing filter 602 in accordance with an embodiment of the invention. Pre-processing filter 602 includes a filter strength determining module 702 and an intensity updating module 704.

Filter strength determining module 702 calculates a weighted filtering strength factor for each of the plurality of pixels in video frame 102. In an embodiment of the present invention, the weighted filtering strength factor is computed using the information received from a spatial filter. The information received includes, but is not limited to, pixel category information, macroblock type, quantization parameter and motion estimation result. The weighted filtering strength factor is communicated to Intensity updating module 704.

Intensity updating module 704 calculates a modified intensity value for each of pixels 106 in video frame 102 using the weighted filtering strengthfactor. In one embodiment of the invention, the modified intensity value for each of pixels 106 is calculated using an attenuation factor. In another embodiment of the invention, a filter weighted filtering strength factor is calculated along with the attenuation factor to determine the modified intensity value.

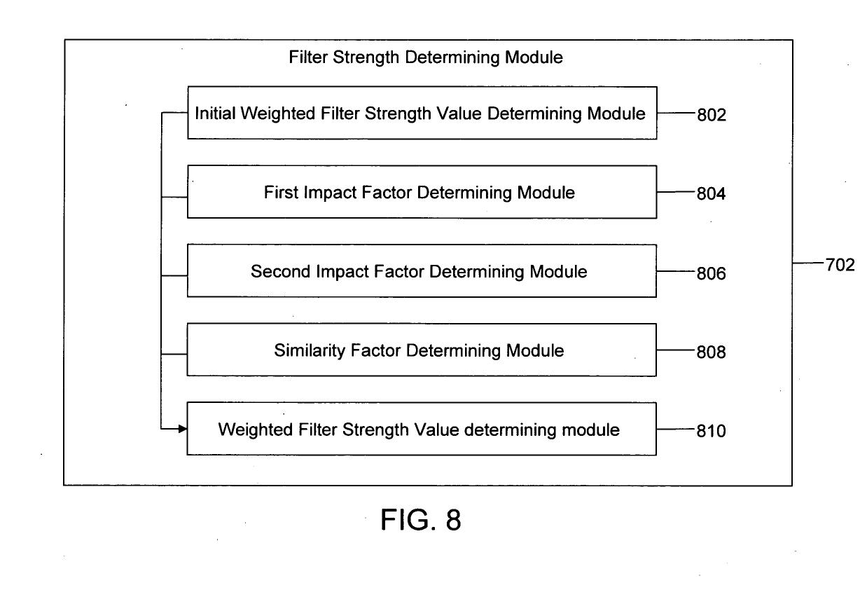

FIG. 8 is a block diagram of filter strength determining module 702, in accordance with an embodiment of the invention. It may be noted that filter strength determining module 702 works in accordance with the method described with reference to FIG. 3.

Filter strength determining module 702 includes an initial weighted filtering strength factor determining module 802, a first impact factor determining module 804, a second impact factor determining module 806, a similarity factor determining module 808 and a weighted filtering strength factor determining module 810.

Initial weighted filtering strength factor determining module 802 calculates an initial value of weighted filtering strength of each of pixels 106. First impact factor determining module 804 calculates a first impact factor for each of macroblocks 104. Second impact factor determining module 806 calculates a second impact factor for each of macroblocks 104. The first impact factor and the second impact factor affect the weighted filtering strength. It is noted that stronger the impact factors, the heavier the filter strength. Similarity factor determining module 808 calculates a similarity factor for each of macroblocks 104. In an embodiment of the present invention, the similarity factor is calculated for a 4×4 size macroblock. The similarity factor also affects the strength of the filter. The higher the similarity factor, the lighter the filter will be. The similarity factor is a measure of quality of motion estimation. Weighted filtering strength factor determining module 810 calculates a final weighted filtering strength factor for each of pixels 106.

In an embodiment of the present invention, the first impact factor, the second impact factor, the third impact factor, and the similarity factor is communicated to the weighted filtering strength factor determining module 810. Weighted filtering strength factor determining module 810 then calculates the weighted filtering strength factor using the above-mentioned factors.

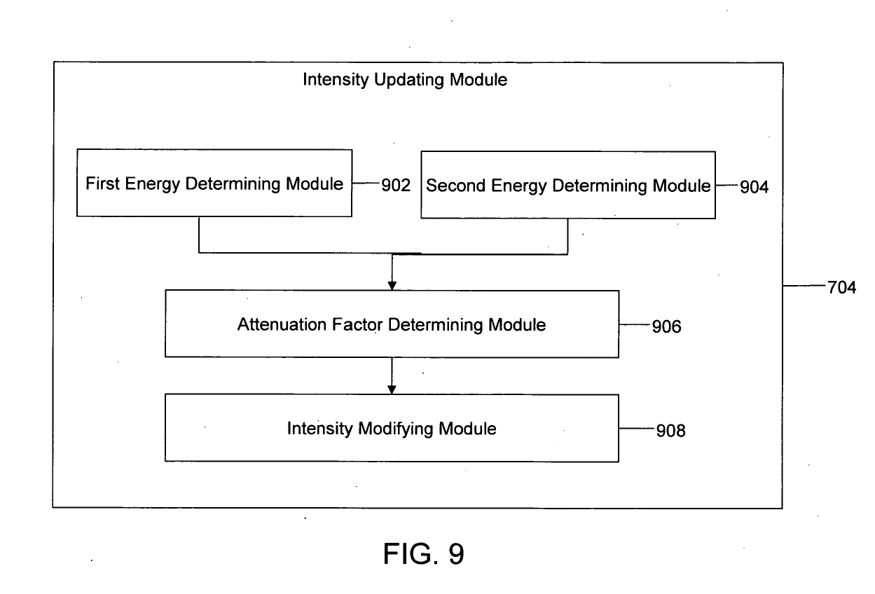

FIG. 9 is a block diagram of Intensity updating module 704, in accordance with an embodiment of the invention. Intensity updating module 704 includes a first energy determining module 902, a second energy determining module 904, an attenuation factor determining module 906, and an intensity modifying module 908. First energy determining module 902 calculates an energy value for each of pixels 106 in the macroblock 104a. Second energy value determining module 904 calculates an energy value for each of pixels 106 after motion compensation on macroblock 104a. Attenuation factor determining module 906 calculates an attenuation factor for macroblock 104a. Intensity modifying module 908 calculates the modified intensity value for each of pixels 106. It may be noted that intensity updating module 704 works in accordance with the method described with reference to FIGS. 4 and 5.

In one embodiment of the invention, first energy determining module 902 and second energy determining module 904 communicate the energy values to attenuation factor determining module 906. Attenuation factor determining module 906 receives the energy values and calculates the attenuation factor using the above-mentioned energy values. Thereafter, the attenuation factor is communicated to intensity modifying module 908. Intensity modifying module 908 attenuates the intensity value of each of pixels 106 based on the attenuation factor. In another embodiment of the invention, the modified intensity value is calculated using a high strength factor and the attenuation factor. The high strength factor is based on quantization parameter, type of macroblock and Sum of Absolute Differences (SAD) information.

The computer program product of the invention is executable on a computer system for causing the computer system to perform a method of filtering an image including an image filtering method of the present invention. The computer system includes a microprocessor, an input device, a display unit and an interface to the Internet. The microprocessor is connected to a communication bus. The computer also includes a memory. The memory may include Random Access Memory (RAM) and Read Only Memory (ROM). The computer system further comprises a storage device. The storage device can be a hard disk drive or a removable storage drive such as a floppy disk drive, optical disk drive, etc. The storage device can also be other similar means for loading computer programs or other instructions into the computer system. The computer system also includes a communication unit. The communication unit allows the computer to connect to other databases and the Internet through an I/O interface. The communication unit allows the transfer as well as reception of data from other databases. The communication unit may include a modern, an Ethernet card, or any similar device that enables the computer system to connect to databases and networks such as LAN, MAN, WAN and the Internet. The computer system facilitates inputs from a user through input device, accessible to the system through I/O interface.

The computer system executes a set of instructions that are stored in one or more storage elements, in order to process input data. The set of instructions may be a program instruction means. The storage elements may also hold data or other information as desired. The storage element may be in the form of an information source or a physical memory element present in the processing machine.

The set of instructions may include various commands that instruct the processing machine to perform specific tasks such as the steps that constitute the method of the present invention. The set of instructions may be in the form of a software program. Further, the software may be in the form of a collection of separate programs, a program module with a larger program or a portion of a program module, as in the present invention. The software may also include modular programming in the form of object-oriented programming. The processing of input data by the processing machine may be in response to user commands, results of previous processing or a request made by another processing machine.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

Furthermore, throughout this specification (including the claims if present), unless the context requires otherwise, the word “comprise”, or variations such as “comprises” or “comprising”, will be understood to imply the inclusion of a stated element or group of elements but not the exclusion of any other element or group of elements. The word “include,” or variations such as “includes” or “including,” will be understood to imply the inclusion of a stated element or group of elements but not the exclusion of any other element or group of elements. Claims that do not contain the terms “means for” and “step for” are not intended to be construed under 35 U.S.C. § 112, paragraph 6.

What is claimed is:

1. A method of processing a video sequence, the video sequence comprising a plurality of video frames, each of the plurality of video frames comprising a plurality of macroblocks, each of the plurality of macroblocks comprising a plurality of pixels, the method comprising:
a) determining a respective first energy value for each of the plurality of pixels in a first macroblock;
b) determining a respective second energy value for each of the plurality of pixels in a second macroblock;
c) determining a respective attenuation factor for each of the plurality of pixels in the first macroblock based on the first energy value, the second energy value and a respective weighted filtering strength factor associated with each of the plurality of pixels in the first macroblock; and
d) determining a modified intensity value for each of the plurality of pixels in the first macroblock based on the respective attenuation factor for each of the plurality of pixels in the first macroblock, a respective intensity value of each of the plurality of pixels in the first macroblock and a mean intensity value of the first macroblock.

2. The method according to claim 1, wherein the respective first energy value is based on the respective intensity value of each of the plurality of pixels in the first macroblock and the mean intensity value of the first macroblock.

3. The method according to claim 1, wherein the respective second energy value is based on a respective intensity value of each of the plurality of pixels in the second macroblock and a mean intensity value of the second macroblock.

4. The method according to claim 1, wherein the respective weighted filtering strength factor for each of the plurality of pixels in the first macroblock is determined based on an initial weighted filtering strength factor, a first impact factor, a second impact factor, a similarity factor and a mathematical function.

5. The method according to claim 4 further comprising determining the initial weighted filtering strength factor based on a respective predetermined category associated with each of the plurality of pixels in the first macroblock.

6. The method according to claim 4 further comprising determining the first impact factor for each of the plurality of pixels in the first macroblock based on dimensions of the first macroblock.

7. The method according to claim 4 further comprising determining the second impact factor for each of the plurality of pixels in the first macroblock based on a quantization parameter associated with the first macroblock.

8. The method according to claim 4 further comprising determining the similarity factor based on motion estimation performed for the first macroblock.

9. A system for processing a video sequence, the video sequence comprising a plurality of video frames, each of the plurality of video frames comprising a plurality of macroblocks, each of the plurality of macroblocks comprising a plurality of pixels, the system comprising:
a) a filter strength determining module to determine a weighted filtering strength factor for each of the plurality of pixels in a first macroblock; and
b) an intensity updating module to determine an updated intensity value for each of the plurality of pixels in the first macroblock using the weighted filtering strength factor.

10. The system according to claim 9, wherein the filter strength determining module comprises:
a) an initial weighted filtering strength factor determining module to determine an initial weighted filtering strength factor for each of the plurality of pixels in a first macroblock;
b) a first impact factor determining module to determine a first impact factor for each of the plurality of pixels in the first macroblock;
c) a second impact factor determining module to determine a second impact factor for each of the plurality of pixels in the first macroblock;
d) a similarity factor determining module to determine a similarity factor for each of the plurality of pixels in the first macroblock; and
e) a weighted filtering strength factor determining module to determine a respective weighted filtering strength factor for each of the plurality of pixels in the first macroblock.

11. The system according to claim 10, wherein the initial weighted filtering strength factor is based on a respective predetermined category associated with each of the plurality of pixels in the first macroblock.

12. The system according to claim 10, wherein the first impact factor is based on the dimensions of the first macroblock.

13. The system according to claim 10, wherein the second impact factor is based on a quantization parameter associated with the first macroblock.

14. The system according to claim 10, wherein the similarity factor is based on motion estimation performed for the first macroblock.

15. The system according to claim 10, wherein the weighted filtering strength factor is based on the initial weighted filtering strength factor, the first impact factor, the second impact factor, the similarity factor and a mathematical function.

16. The system according to claim 9, wherein the intensity updating module comprises:
a) a first energy determining module to determine a respective first energy value for each of the plurality of pixels in a first macroblock of a first video frame;
b) a second energy determining module to determine a respective second energy value for each of the plurality of pixels in a second macroblock of a second video frame;
c) an attenuation factor determining module to determine a respective attenuation factor for each of the plurality of pixels; and
d) an intensity modifying module to determine a modified intensity value for each of the plurality of pixels in the first macroblock based on the attenuation factor.

17. The system according to claim 16, wherein the respective first energy value is based on a respective intensity value of each of the plurality of pixels in the first macroblock and a mean intensity value of the first macroblock.

18. The system according to claim 16, wherein the respective second energy value is based on a respective intensity value of each of the plurality of pixels in the first macroblock and a mean intensity value of the first macroblock.

19. The system according to claim 16, wherein the respective attenuation factor is based on the first energy value, the second energy value and a respective weighted filtering strength factor associated with each of the plurality of pixels in the first macroblock.

20. A computer program product for processing a video sequence, the video sequence comprising a plurality of video frames, each of the plurality of video frames comprising a plurality of macroblocks, each of the plurality of macroblocks comprising a plurality of pixels, the computer program product comprising:
a) program instruction means for determining a respective first energy value for each of the plurality of pixels in a first macroblock;
b) program instruction means for determining a respective second energy value for each of the plurality of pixels in a second macroblock;
c) program instruction means for determining a respective attenuation factor for each of the plurality of pixels in the first macroblock based on the first energy value, the second energy value and a respective weighted filtering strength factor associated with each of the plurality of pixels in the first macroblock; and
d) program instruction means for determining a modified intensity value for each of the plurality of pixels in the first macroblock based on the respective attenuation factor for each of the plurality of pixels in the first macroblock, a respective intensity value of each of the plurality of pixels in the first macroblock and a mean intensity value of the first macroblock.
